(19) United States
(12) Patent Application Publication
(10) Pub. No.: US 2004/0095638 A1
(43) Pub. Date: May 20, 2004

(54) Method for evaluating layers of images

(76) Inventors: Thomas Engel, Erfurt OT Niedernissa (DE); Volker Herbig, Erfurt (DE)

Correspondence Address: Gerald H Kiel, Reed Smith, 599 Lexington Avenue, New York, NY, 10022-7650, US

(21) Appl. No.: 10/471,520

(22) PCT Filed: Mar. 15, 2002
(86) PCT No.: PCT/EP02/02881

(30) Foreign Application Priority Data
Mar. 17, 2001 (DE) 101 12 947.5

(51) Int. Cl. G02B 21/00

(52) U.S. Cl. 359/368

(57) ABSTRACT

The invention is directed to a method for evaluating layer images (A, B, C, D, E) which are recorded by microscope from planes of different depths in focusing direction z of an object. Every layer image (A, B, C, D, E) is composed of a plurality of image points (Aᵢⱼ, Bᵢⱼ, Cᵢⱼ, Dᵢⱼ, Eᵢⱼ); an intensity value is determined for every image point (Aᵢⱼ, Bᵢⱼ, Cᵢⱼ, Dᵢⱼ, Eᵢⱼ) or for image areas comprising a plurality of these image points (Aᵢⱼ, Bᵢⱼ, Cᵢⱼ, Dᵢⱼ, Eᵢⱼ); the intensity values for image points (Aᵢⱼ, Bᵢⱼ, Cᵢⱼ, Dᵢⱼ, Eᵢⱼ) or image areas lying one above the other in z-direction are combined; a parameter characteristic of these image points (Aᵢⱼ, Bᵢⱼ, Cᵢⱼ, Dᵢⱼ, Eᵢⱼ) or image areas is determined and ordered within a grid corresponding to the grid of the image points (Aᵢⱼ, Bᵢⱼ, Cᵢⱼ, Dᵢⱼ, Eᵢⱼ). In this way, information about the topography of the object, for example, can be obtained and displayed.

### CROSS-REFERENCE TO RELATED APPLICATIONS

This application claims priority of International Application No. PCT/EP02/02881, filed Mar. 17, 2002 and German Application No. 101 12 947.5, filed Mar. 17, 2001, the complete disclosures of which are hereby incorporated by reference.

### BACKGROUND OF THE INVENTION

1. Field of the Invention

The invention is directed to a method for evaluating layer images which are recorded by microscope from planes of different depths in focusing direction z of an object.

2. Description of the Related Art

In scanning microscopy, an object being examined is scanned point by point under defined conditions of measurement light. In so doing, the intensity of the measurement light is detected for each individual object point and an equivalent of the intensity value is associated in each instance with an image point of an image.

As a rule, images of an object space or images from different object depths are generated in this way from a plurality of different planes in the focusing direction, which usually corresponds to the z-direction. Information about characteristics of the examined object can then be obtained from the measured intensity values. For example, information about the fine surface structure or the layer construction of an object can be obtained in this way. This is important for the inspection of semiconductor components, particularly wafers, among other things.

Confocal scanning microscopes working in the range of visible light that is usable for this purpose or in the near UV range are already known in general. Image recording is carried out, for example, by means of a Nipkow disk. A confocal scanning microscope of this kind is described in German Patent 195 11 937

In polychromatic confocal scanning microscopes, the bandwidth of the visible light with its different wavelengths is used for recording layer images. The light of different wavelengths is imaged on observation planes located at various depths. In this case, intensity values from the different planes can be detected by a measuring process.

By contrast, it is also possible to record the layer images with monochromatic confocal scanning microscopes or with laser scanning microscopes. For this purpose, the individual planes are successively brought into focus and the intensity of the measurement light is detected in each instance.

### OBJECT AND SUMMARY OF THE INVENTION

Proceeding from this prior art, it is the primary object of the invention to provide an improved method for evaluating the layer images obtained in scanning microscopy by which precise information about object characteristics can be obtained in an efficient manner.

This object is met by a method of the type mentioned above, wherein every layer image (A, B, C, D, E) is composed of a plurality of image points (Aᵢⱼ, Bᵢⱼ, Cᵢⱼ, Dᵢⱼ, Eᵢⱼ) arranged in a grid, an intensity value is determined for every image point (Aᵢⱼ, Bᵢⱼ, Cᵢⱼ, Dᵢⱼ, Eᵢⱼ) or for image areas comprising a plurality of these image points (Aᵢⱼ, Bᵢⱼ, Cᵢⱼ, Dᵢⱼ, Eᵢⱼ), the intensity values for image points (Aᵢⱼ, Bᵢⱼ, Cᵢⱼ, Dᵢⱼ, Eᵢⱼ) or image areas lying one above the other in z-direction are combined according to given criteria, a parameter characteristic of these image points (Aᵢⱼ, Bᵢⱼ, Cᵢⱼ, Dᵢⱼ, Eᵢⱼ) or image areas is determined, and the parameters relating to these image points (Aᵢⱼ, Bᵢⱼ, Cᵢⱼ, Dᵢⱼ, Eᵢⱼ) or image areas are correlated with the elements of a grid corresponding to the grid of the image points (Aᵢⱼ, Bᵢⱼ, Cᵢⱼ, Dᵢⱼ, Eᵢⱼ) in a layer image (A, B, C, D, E).

By image points (Aᵢⱼ, Bᵢⱼ, Cᵢⱼ, Dᵢⱼ, Eᵢⱼ) is meant, for example, the pixels or subpixels of an LC display; consequently, image areas may comprise a plurality of neighboring pixels or subpixels of a display of this kind. In other words, the image points (Aᵢⱼ, Bᵢⱼ, Cᵢⱼ, Dᵢⱼ, Eᵢⱼ) are the smallest units on which image information can be displayed or by which image information can be detected, while the above-mentioned image areas extend over a larger surface area than the image points (Aᵢⱼ, Bᵢⱼ, Cᵢⱼ, Dᵢⱼ, Eᵢⱼ). The image areas in the different planes lying one above the other in z-direction can be of different sizes, i.e., they can comprise different quantities of image points (Aᵢⱼ, Bᵢⱼ, Cᵢⱼ, Dᵢⱼ, Eᵢⱼ) in different planes. The size of the image areas depends, for example, upon defocusing while determining the measurement values. For the sake of simplicity, the invention will be described in the following only with reference to the evaluation of individual image points (Aᵢⱼ, Bᵢⱼ, Cᵢⱼ, Dᵢⱼ, Eᵢⱼ).

Using the given criteria, determined characteristics of the object at the specified location can be determined for every recorded object point or for the immediate vicinity of the object point. For example, information about the geometry of the object surface or about the geometry of a boundary surface can be derived from the intensity values. By deliberately condensing or selecting such information, a data field similar to the grid structure of the layer images can then be generated, and this data field can be displayed graphically.

In an advantageous arrangement of the invention, the extremal value of the intensity values is determined for the image points lying one above the other. A quantity characterizing the position in z-direction is determined at the extremal intensity value and is correlated with the characteristic parameter. In this way, based on one of the object points lying one above the other whose position in z-direction is known, the layer image having the maximum intensity at this point is determined.

The presence of a boundary layer or surface layer can be deduced from the intensity, so that an image is formed of the characteristic parameters. This image represents a depiction of the surface topography of the object to be examined or the topography of a boundary layer with a determined reflection behavior.

An approximation curve for the intensity variation is preferably generated for the image points lying one above the other in the individual image planes, which approximation curve has the intensity values of these image points as nodal points. A quantity characterizing the position in z-direction is determined for the extremal value of the approximation curve within a depth area and is correlated with the characteristic parameter. This procedure allows a more accurate determination of the position of the intensity maximum which can also be located between the z-position of two adjacent layer images for an object point. A particularly high resolution in z-direction is produced in this way.

In another advantageous arrangement of the invention, the extremal value of the intensity values of the image points lying one above the other is correlated with the characteristic parameter without reference to the z-position. The characteristic parameters for the individual object points accordingly represent information about the spatial reflection behavior of the examined object.

The extremal value of an approximation curve in the vertical object area which is represented by the layer images and which has the intensity values of the image points lying one above the other as nodal points is preferably correlated with the characteristic parameter. In this way, the local intensity maximum can be determined in a particularly accurate manner for the individual object points.

The mathematical methods used for generating the approximation curve are known in general and need not be described more fully herein. However, it is essential that the characteristic parameter is obtained for all object points on the basis of the same criterion, i.e., based on the same approximation rule.

For a particularly highly accurate evaluation it has proven advantageous to determine the function type of the approximation curve by a calibrating process. In particular, this also takes into account the apparatus characteristics of the optical system used for generating the layer images. The calibration curve to be taken as a basis can be determined empirically or can be calculated by a theoretical route.

The grid structure of the elements is adapted to the structure of the image points of the layer images in order to obtain meaningful results which are as accurate as possible. In scanning microscopy, CCD cameras are generally used for generating image information and intensity values. Consequently, it is particularly advantageous when the grid structure of the elements to which the characteristic parameters for the individual object points are assigned is formed of rows and columns.

In another advantageous arrangement of the invention, the layer images are recorded in object planes located equidistant from one another one above the other. This has the advantage that it keeps down computing time for evaluating the image points lying one above the other in the individual object planes, particularly when determining the approximation curves and their maximum.

Of course, it is also possible for the evaluation to be based upon layer images originating from object planes with different relative distances from one another. This can be advantageous particularly when it is difficult to generate equidistant layer images. In this case, additional distance information must be taken into account in the evaluation.

In optical systems which are used, for example, to generate layer images, the resolution depends among other things on the wavelength of the measurement light. When the layer images are generated with measurement light of different wavelengths, they have varying resolution in z-direction.

Therefore, in an advantageous arrangement of the invention, the intensity values of the layer images are related to a monochromatic light. Accordingly, a uniform resolution over the entire object space to be examined is achieved in the z-direction as well as in an xy-plane perpendicular to the z-direction. Layer images of this kind can be obtained, for example, with a monochromatic confocal scanning microscope or also with a laser scanning microscope.

### BRIEF DESCRIPTION OF THE DRAWING

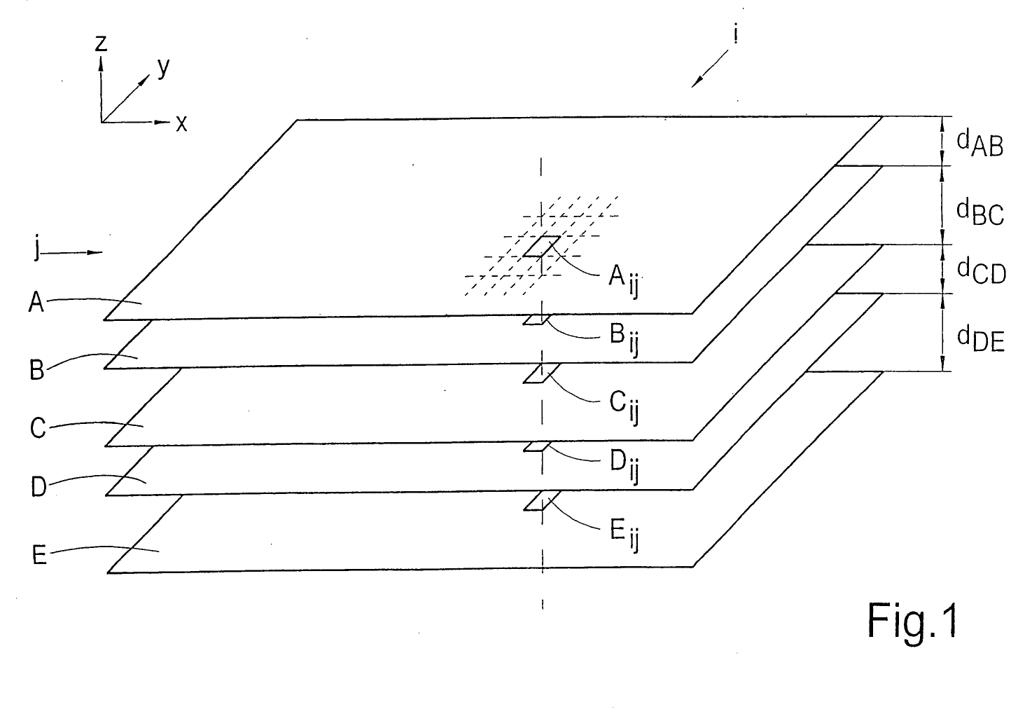

In the accompanying drawing, FIG. 1 is a schematic view of layer images lying one above the other, each of which has a plurality of image points with which intensity values are associated.

### DESCRIPTION OF THE PREFERRED EMBODIMENTS

The invention is described more fully below with reference to an embodiment example.

A plurality of layer images of an object space to be examined are generated by a confocal scanning microscope for different object depths in z-direction. The scanning microscope used for this purpose may be, for example, a confocal scanning microscope which is operated with measurement light in the UV range. The wavelength range of the measurement light is very small, so that a plurality of separate recordings must be made within the framework of a focus series for the individual layer images in the z-direction. These layer images are shown schematically in FIG. I and are designated by A, B, C, D and E. The quantity of layer images is not limited to the quantity shown in FIG. 1, but is essentially freely selectable.

Each of the layer images shown, A, B, C, D, E, has a grid structure with a plurality of image points which are arranged in rows i and columns j. In FIG. 1, the image points Aᵢⱼ, Bᵢⱼ, Cᵢⱼ, Dᵢⱼ, Eᵢⱼ lying one above the other are shown for an object area extending in z-direction along the depth, which corresponds to the sum of distances d_{AB} to d_{DE}.

An intensity value that was measured during the generation of the respective layer image A, B, C, D, E at a reception device of the scanning microscope is associated with each of these image points Aᵢⱼ, Bᵢⱼ, Cᵢⱼ, Dᵢⱼ, Eᵢⱼ. This reception device is usually a matrix of a CCD camera.

Instead of the aforementioned confocal scanning microscope operated in the UV range, a confocal scanning microscope operated with a monochromatic measurement light can also be used. In this case, a very uniform resolution is achieved for all layer images A, B, C, D, E in z-direction. Alternatively, a laser scanning microscope can also be used.

Further, in all cases in which the layer images A, B, C, D, E are recorded successively by focusing on different object planes in z-direction, the distance d_{AB}, d_{BC}, d_{CD} or d_{DE} between neighboring layer images is fixed. Alternatively, the distance from a predetermined reference point (not shown in the drawing) to each individual layer image A, B, C, D, E or to the associated object plane can be recorded.

Further, it is conceivable to generate the layer images A, B, C, D, E by means of a broadband polychromatic confocal scanning microscope in which focusing in z-direction is carried out by wavelength selection. This is also possible in an analogous manner when operating the confocal scanning microscope in the visible spectral range of light insofar as the resulting image is broken down into color values with which depth information is correlated.

The intensity values recorded in the individual layer images A, B, C, D, E for the image point Aᵢⱼ, Bᵢⱼ, Cᵢⱼ, Dᵢⱼ, Eᵢⱼ can be evaluated in different ways, as will be described more fully in the following, in order to obtain information about object characteristics.

A “best focus image” is generated from the layer images to show the topography of the objet under examination. The effect whereby a clear intensity peak is adjusted when the scanning microscope is focused on a boundary surface is utilized for this purpose. This is especially clearly pronounced at the object surface. Beyond this, less distinctly pronounced secondary intensity peaks can occur in partially transparent bodies.

In order to generate the best focus image, the image points of the layer images lying one above one another, i.e., the image points with the same index, are evaluated according to a predetermined criterion while generating a characteristic parameter. In the embodiment example, this criterion is an approximation curve determined by type with which the intensity curve is approximated or fitted in the object depth range represented by the layer images A, B, C, D and E.

The intensity values measured at the individual image points Aᵢⱼ, Bᵢⱼ, Cᵢⱼ, Dᵢⱼ, Eᵢⱼ form the nodal points of the approximation curve. Further, the distances d_{AB}, d_{BC}, d_{CD} and d_{DE} between the layer images A, B, C, D, E in z-direction are taken into account when parameterizing the approximation curve. Insofar as these distance d_{AB}, d_{BC}, d_{CD}, d_{DE} are identical for all adjacent layer images A, B, C, D, E, this can even be taken into account in the function rule, so that the approximation curve can be parameterized based on the intensity values alone.

For the approximation curve, the extremal value of the intensity is determined within the above-mentioned object depth range and the associated position in z-direction is determined with reference to this extremal value.

Therefore, a pair of values consisting of a value for the intensity and a z-quantity is obtained. When the best focus image is generated, this z-quantity and an element of a grid structure that is very similar to the grid structure of the image points Aᵢⱼ, Bᵢⱼ, Cᵢⱼ, Dᵢⱼ, Eᵢⱼ in a layer image A, B, C, D, E are assigned to the characteristic parameter.

In this way, the characteristic parameters can be determined over all indices and can be collected in a data field. This data field is then displayed, e.g., visually, as best focus image, which is a synthetic image.

Due to the similarity of the grid structure to that of the image points Aᵢⱼ, Bᵢⱼ, Cᵢⱼ, Dᵢⱼ, Eᵢⱼ, an image results which contains scaled topographic information. Since the displayed information is based on object points that are actually measured, a quantitative scaling is achieved in contrast to confocal scanning microscopes in which a chromatic observation is carried out.

The approximation curves mentioned above can also be evaluated with respect to the extremal value of the intensity for the individual image points Aᵢⱼ, Bᵢⱼ, Cᵢⱼ, Dᵢⱼ, Eᵢⱼ, and, therefore, for the corresponding object points and can be assembled to form a synthetic image. In this case, the respective maximum intensity value of the approximation curve in the object depth range represented by the layer images A, B, C, D, E is correlated with the characteristic parameter. The synthetic image then gives an isodose distribution of the extremal intensity which can be evaluated further.

With structured surfaces in which different materials differ with respect to their refection behavior, the materials and therefore the structure planes can be displayed in a corresponding manner. For the purpose of quantification of the synthetic images generated in this way, a calibration is possibly carried out beforehand at a surface with constant reflectivity, e.g., a mirror.

In a simplified modification of the method steps mentioned above, the generation of an approximation curve is omitted. Instead, for purposes of displaying the topography in the form of a best focus image, the z-quantity of the layer image A, B, C, D, E at which the intensity maximum for the image points Aᵢⱼ, Bᵢⱼ, Cᵢⱼ, Dᵢⱼ, Eᵢⱼ lying one above the other is determined is directly correlated with the characteristic parameter of an object point.

On the other hand, for displaying the isointensity surfaces, the maximum intensity value is directly correlated with the characteristic parameter from the image points Aᵢⱼ, Bᵢⱼ, Cᵢⱼ, Dᵢⱼ, Eᵢⱼ lying one above the other.

When the method described above is used to examine a layer system having a plurality of layers of identical constitution and reflectivity, both the best focus image and the isointensity surface depiction are used for obtaining information, e.g., in order to show isodose distributions on depth structures and, accordingly, to resolve the structure of the layer system.

Further, additional information about properties of the object can be derived from the approximation curves or evaluation functions, for example, by comparing with reference curves. For example, in at least partially transparent objects, boundary layers located within the object can be deduced based on the determination of secondary maxima. When the object to be measured is fundamentally known with respect to its structure, defective locations can be deduced based on intensity deviations that are determined in this manner.

The method according to the invention can be carried out in incident light operation as well as transmitted light operation.

While the foregoing description and drawings represent the present invention, it will be obvious to those skilled in the art that various changes may be made therein without departing from the true spirit and scope of the present invention.

Reference Numbers:

A, B, C, D, E layer images

Aᵢⱼ, Bᵢⱼ, Cᵢⱼ, Dᵢⱼ, Eᵢⱼ image point

i rows

j columns

d_{AB}, d_{BC}, d_{CD}, d_{DE} distances

1. Method for evaluating layer images (A, B, C, D, E) which are recorded by microscope from planes of different depths in focusing direction z of an object, wherein every layer image (A, B, C, D, E) is composed of a plurality of image points (Aᵢⱼ, Bᵢⱼ, Cᵢⱼ, Dᵢⱼ, Eᵢⱼ) arranged in a grid, an intensity value is determined for every image point (Aᵢⱼ, Bᵢⱼ, Cᵢⱼ, Dᵢⱼ, Eᵢⱼ) or for image areas comprising a plurality of these image points (Aᵢⱼ, Bᵢⱼ, Cᵢⱼ, Dᵢⱼ, Eᵢⱼ), the intensity values for image points (Aᵢⱼ, Bᵢⱼ, Cᵢⱼ, Dᵢⱼ, Eᵢⱼ) or image areas lying one above the other in z-direction are combined according to given criteria, a parameter characteristic of these image points (Aᵢⱼ, Bᵢⱼ, Cᵢⱼ, Dᵢⱼ, Eᵢⱼ) or image areas is determined, and the parameters relating to these image points (Aᵢⱼ, Bᵢⱼ, Cᵢⱼ, Dᵢⱼ, Eᵢⱼ) or image areas are correlated with the elements of a grid corresponding to the grid of the image points (Aᵢⱼ, Bᵢⱼ, Cᵢⱼ, Dᵢⱼ, Eᵢⱼ) in the layer images (A, B, C, D, E).

2. Method according to claim 1, characterized in that the extremal value of the intensity values is determined for image points (Aᵢⱼ, Bᵢⱼ, Cᵢⱼ, Dᵢⱼ, Eᵢⱼ) lying one above the other, a quantity characterizing the position in z-direction is then determined at this extremal intensity value and is assigned as a value to the characteristic parameter.

3. Method according to claim 1, characterized in that an approximation curve for an intensity variation is generated for each of the depths in focusing direction z in which a layer image (A, B, C, D, E) is obtained, wherein the intensity values of the image points (Aᵢⱼ, Bᵢⱼ, Cᵢⱼ, Dᵢⱼ, Eᵢⱼ) or image areas lying one above serve as nodal points, the extremal value of the approximation curve is determined according to the latter, and a quantity characterizing the position in z-direction is then determined and is assigned as a value to the characteristic parameter.

4. Method according to claim 1, characterized in that the extremal value of the intensity values of the image points (Aᵢⱼ, Bᵢⱼ, Cᵢⱼ, Dᵢⱼ, Eᵢⱼ) or image areas lying one above the other is correlated with the characteristic parameter.

5. Method according to claim 1, characterized in that the extremal value of an approximation curve within the vertical object area which is represented by the layer images (A, B, C, D, E) is correlated with the characteristic parameter, wherein the approximation curve has the intensity values of the image points (Aᵢⱼ, Bᵢⱼ, Cᵢⱼ, Dᵢⱼ, Eᵢⱼ) or image areas lying one above the other as nodal points.

6. Method according to claim 3 or 5, characterized in that the function type of the approximation curve is determined by a calibrating process.

7. Method according to one of the preceding claims, characterized in that the grid structure is composed of rows and columns.

8. Method according to one of the preceding claims, characterized in that the distances, measured in z-direction, between the planes from which the layer images (A, B, C, D, E) are recorded are equal.

9. Method according to one of the preceding claims, characterized in that the intensity values relate to monochromatic light.

10. Method according to one of the preceding claims, characterized in that the intensity values for the image points (Aᵢⱼ, Bᵢⱼ, Cᵢⱼ, Dᵢⱼ, Eᵢⱼ) or image areas are obtained by a confocal scanning microscope with Nipkow disk or a laser scanning microscope.
